(19) United States
(12) Patent Application Publication
(10) Pub. No.: US 2009/0138379 A1
(43) Pub. Date: May 28, 2009

(54) SYSTEM AND METHOD FOR INTERNATIONAL INTERNET SHOPPING

(76) Inventor: Ronald Scheman, Charleston, SC (US)

Correspondence Address: KELLEY DRYE & WARREN LLP, 400 ALTLANTIC STREET , 13TH FLOOR, STAMFORD, CT, 06901, US

(21) Appl. No.: 12/270,519

(22) Filed: Nov. 13, 2008

Related U.S. Application Data
(60) Provisional application No. 60/988,292, filed on Nov. 15, 2007.

(51) Int. Cl. G06Q 30/00

(52) U.S. Cl. 705/27; 705/26

(57) ABSTRACT

A method and system for providing international consumers without bank accounts, or recognizable addresses the ability to shop and purchase goods in a language and currency recognized by the consumer with foreknowledge of the full landed costs to remote locations.

All references cited in this specification, and their references, are incorporated by reference herein where appropriate for teachings of additional or alternative details, features, and/or technical background. This application claims benefit of Provisional Application Ser. No. 60/988,292, filed Nov. 15, 2007.

### BACKGROUND OF THE INVENTION

1. Field of the Invention

The present invention generally relates to international online commerce using a computer network.

2. Description of the Related Art

As the acceptance of the internet by the general population has increased over the recent past, user confidence has risen as well. The rise in confidence is partly do to increased security efforts, such as the implementation of more rigorous protocols like HTTP(s) and Secure Sockets Layer (SSL). One result of this greater confidence is the overwhelming growth in the e-commerce sector. E-commerce is the strategic use of computers and networks to support the transaction of goods, and facilitates the desire of a consumer to purchase goods without the binds of time and location and the desire of a vendor to offer and sell goods to a wider array of potential consumers. The transaction of goods as herein described, may be deemed to include services known in the art of commerce.

An e-commerce vendor typically establishes a web server connected to the internet to host his website or makes use of a service to perform such web hosting. Virtual store-fronts offer speed and convenience of shopping to both the consumer and the merchant. Consumers benefit from being able to shop 24 hours a day with no concern for the time of day at the retailer, the website provider or at the consumer's location.

Purchasing involves: selecting items, storing the selected items in a “shopping cart” database, and “checking out” by means of indicating a shipping method and destination, and presenting a desired form of payment via cryptographic protocols like TLS and HTTPS. Payment is typically by credit card or an alternative account services linked to a credit card, such as Pay Pal.

With such conveniences, there are still several obstacles that many potential consumers and e-merchants, especially those in untapped markets have heretofore not been able to overcome. The current system, is not optimized for potential international consumers who lack recognizable addresses, bank accounts, or foreign language skills to remotely participate. The current system is further not optimized to view product information in the consumer's native language, purchase goods with a foreknowledge of the full landed costs in the consumer's native currency, or drop ship goods to remote locations (allow visiting nationals to send product to their home country). The current system is further not optimized to equip vendors with tools to operate in a truly global e-commerce environment. It is not optimized to allow small businesses to take advantage of the wealth of goods or pricing benefits offered by having access to vendors throughout the United States, Europe and Asia nor does it allow vendors to apply targeted advertising of their products to the global market.

Although the internet was anticipated to level the playing field for e-commerce vendors, the smaller vendor sites can not afford to implement necessary credit card fraud measures. Many online merchants avoid global sales all together to protect themselves from the results of credit issued to those stealing identities of legitimate consumers; the majority of identity theft information finding it's way oversees. A full one-third of medium and large Websites simply won't sell to international customers.¹ Better than one in ten e-commerce credit card purchases from certain countries are fraudulent. Persistently high fraud rates and lack of inexpensive, effective fraud-fighting tools has dampened the global use of electronic commerce. ¹ Foreign fraud hits U.S. e-commerce firms hard., (http://msnbc.msn.com/id/4648378/)

Even without credit card fraud and the associated identity theft, many consumers are without access to e-commerce because of their remote locations and or lack of physical shipping addresses. International e-commerce vendors may not be able to resolve a consumer's address in a foreign country or may not have access to shippers capable of delivering to such remote locations. There is presently no capacity for consumers to shop online and receive goods at their remote location.

Another disadvantage of current e-commerce system and methods relates to a consumer who is not skilled in the language or currency of a vendor's website. The majority of sites will be in a foreign language and currency not familiar to a consumer in a remote location. Potential e-commerce consumers in these untapped markets, such as the countries of South America are inhibited from shopping online if the vendors can not provide for the various languages and currencies necessary to facilitate the shopping experience.

Furthermore, consumers require an understanding of the total costs associated with any purchase to make informed decisions. Present e-commerce practice does not provide sufficient detail to establish the full landed costs of the purchase to the consumer, nor provide such information in a multi-language/currency format. Vendors are not inclined to support global shipping responsibilities to numerous remote locations or account for fluctuating exchange rates of foreign currencies, or inconsistencies of local and international laws, customs and duties. Vendors presently do not have the capacity to properly inform the consumer of all the costs associated with receipt of the goods for which they would like to purchase.

In view of the foregoing, there are desired improved methods and systems therefore which enable untapped and otherwise unavailable e-commerce markets for consumers and vendors. Such methods and systems would allow for a more beneficial, fair and available e-commerce system than previously possible, therefore improving overall commerce and well being.

### SUMMARY OF THE INVENTION

There is provided herein exemplary embodiments directed to international Internet shopping providing a system and method for consumers to experience e-commerce in their native language and acquire goods from otherwise unusable sources and obtain full landed costs to a remote location in the native currency of said consumer.

In one embodiment, there is disclosed a computer implemented transaction method for allowing a user at a remote location without an acceptable distributed network address for shipment of a product or a valid bank account to purchase products over a distributed network, said method comprising the steps of: associating with said remote location an acceptable distributed network address, such as mapping a non-U.S. Internet Protocol (IP) address to an acceptable and recognizable U.S. IP address and/or a physical remote address to a local U.S. physical address; obtaining from said remote location a selection of products to purchase; determining the full landed costs to deliver said selected products to said remote location taking into account the location of the remote location, as well as the weight and the dimensions of the selected products; transmitting the full landed costs to the remote location; accepting from the remote location after transmission of said full landed cost an indication to complete the purchase of one or more selected products; providing an invoice to the remote location for presentation to a remote bank maintaining a bank account operatively configured to communicate with said distributed network; accepting from said remote bank an indication payment related to the invoice has been made; authorizing shipment of said one or more selected products to and acceptable distribution shipment address; and causing shipment of said one or more selected products from said acceptable distribution shipping address to said remote location. The computer implemented method may further comprise in full or in part and without limitation the steps of: obtaining from the remote location a request for quote on said selection of products offered from a non-affiliated vendor; accepting product data content in a foreign language; translating said product data content to an alternate language; transmitting said translated content data to the remote location; transmitting to the user an indication the shipment of one or more selected products has arrived; and receiving from the remote location indication of payment into a debit account prior to selection of one or more products for purchase and from which monies can be drawn to complete the transaction. The full landed cost may be in a user selected currency, and the alternate language may be selected by the user. Payment to a non-affiliated vendor may be made on behalf of the remote location using payment methods comprising: credit card, wire transfer, and/or invoicing.

In another embodiment, there is disclosed a computer implemented system for providing translated content data and full landed costs to e-commerce participants without bank accounts or recognizable addresses, said system comprising: a program interface operatively connected to an e-commerce platform, wherein the program can be a remote application program interface or a web service interface; a vendor catalog and content interface operatively connected to the e-commerce platform or a catalog-less portal connecting consumers to e-commerce enabled vendors through service oriented architecture web services; a content language translator operatively configured to receive the vendor catalog and content and return the vendor catalog and content in a language selected by a user; a pricing module operatively configured to receive product harmonized codes and addressing data from multiple sources such as a logistics provider, wherein said pricing module is configured to determine the full landed cost of a product to the user; a payment and confirmation processing module operatively interfaced to facilitate payment and order release for the product to the user; and a non-catalog product quote module operatively interfaced to the e-commerce platform and associated with a table of non-catalog preferred vendors.

### BRIEF DESCRIPTIONS OF DRAWINGS

Embodiments of the invention are illustrated in the accompanying drawings in which:

FIG. 1 is a block diagram illustrating an exemplary embodiment of an e-commerce system;

FIG. 2a-2d is a process flow-chart diagram illustrating an exemplary embodiment of a transaction system;

FIG. 3 is a diagramatic illustration of an exemplary embodiment of a transaction payment system;

FIG. 4a-4b is a process flow-chart diagram illustrating an exemplary embodiment of a transaction system; and

FIG. 5 is a diagramatic illustration of an exemplary embodiment of interaction between the software and the vendors.

### DETAILED DESCRIPTION OF THE INVENTION

There is disclosed in embodiments herein an international Internet shopping system and method for consumers whom may not have bank accounts or recognizable addresses to experience e-commerce in their native language and currency and acquire goods from otherwise unavailable sources, and obtain in real-time the full landed costs of the purchase to a remote location in the native currency of said consumer. One such system and method is known as the ‘Imalls’ platform and process. Further disclosed is a system and method wherein the consumer can pay for purchases without a bank account, a credit card or other electronic form of payment, and ship or have shipped the purchased goods to a remote location or drop shipped to an alternative remote location. Full landed costs may comprise shipping charges, custom duties, value added taxes (VAT's), fees, tariffs and any other costs known in the art of national and international commerce and associated with the shipment of goods. The full landed costs are related to the remote location to which the consumer would like the articles shipped, which does not necessarily have to be the same location from which the articles are purchased. Just as a remote IP address can be associated or mapped to a local U.S. IP address, so to can a remote physical address be associated or mapped to a local U.S. physical address, such as a distribution center. Such embodiments allow for the consumer to make an educated decision about his spending.

Logistic facilities in remote locations around the world are provided whereby a consumer may e-shop for goods. The facilities, such as a Telecenter, provide the potential consumer with access to a computer and browser, or browser equivalent, where they can shop a native language catalog or portal to vendor sites via service oriented architecture web services and interact with other catalogs or websites from other providers in a language and currency native to the consumer. Central logistic facilities are also provided whereby vendors ship goods to be routed to the consumer directly in the remote locations or to the logistic facilities in the remote locations. Central logistic facilities may provide warehousing as well as the capacity to process orders nationally or internationally. The central facility may provide support for the system, and specifically the Imalls platform and Imalls processes.

Websites may be associated with product and service databases that are presented to the consumer by way of one or more web pages. The web pages may take the shape of a form and provide the consumer goods from vendors classified by tier. Servers and software provide interaction with databases containing a content catalog rich of items. In one embodiment consumers may purchase from a catalog of goods supplied from first tier vendors and affiliates. Such goods may be made available by a primary database of such first tier vendors. Consumers may shop this primary database, select and purchase items to be delivered to their remote location, or a separate location, distinct from the consumers. Consumers may use a browser, or a form of a browser to gain access to the internet to shop via a dedicated site configured to provide the shopper with global access to e-commerce sites

In an alternative embodiment, the catalog of goods which consumers may purchase goods from are supplied from second tier vendors. Such goods may be made available by the primary database or a secondary database of such second tier vendors, The secondary database may be distinct from the primary database. The system may provide methods to use a portal so consumers may shop the database, select and purchase items to be delivered to their remote location, or a separate location distinct from the consumers.

In still another embodiment, the goods which consumers may purchase are supplied from third tier vendors. Third tier vendors may have an e-commerce site having goods for sale, and may not necessarily be associated with the primary or secondary databases. Such goods may be made available by one or more databases kept by third parties. The goods may be for sale within the consumer's present country or outside the country and might otherwise not available for sale to the consumer. The consumer may select items for purchase and be provided the means to requisition such items. A requisition, in the form of an online form, may be sent to the consumer. The requisition form may contain product information such as the site's Universal Resource Locator (URL), a detailed description, product code and a price. The product information may be supplemented by other data, including but not limited to images the consumer may use to correctly identify the goods of interest.

In one embodiment, third tier vendors may be selected “on-the-fly” to fill requests for quotes where the product sought is not available from vendors on the first two tiers. A means is provided which will allow the customer to define the product details on a request for quote form that will be routed to the system service personnel or an automated system. A program and associated system may include the ability for the consumer to search Internet web sites and when the product is found the consumer is provided a Request-for-Quote means, such as a button to submit his selection. When selected, the system can capture an image of the website and URL into the request for quote form. The service personnel or automated system will search a list of pre-screened vendors for the product to prepare a quotation. If the product is not found, the system can search for the product on the open Internet and respond to the consumer with a quotation. The quotation may take the form of an email, instant message or direct mail, and include the fully landed cost of the articles sought in a language and currency native to the consumer. The communication, may contain a method to respond to the quote, such as a method to accept or decline the offer. If the consumer accepts the offer by responding to the system, the order will be further processed.

Remote locations may be provided throughout the world where consumers can gain access to the catalogs of goods and other e-commerce sites of interest. The consumer may be provided automatic language translation of the vendor's website and catalog content to a language consistent with the consumer's location and preferences. The consumers may use the remote locations as centers for, among other traditional consumer related activities, requisitioning, ordering, purchasing, and receiving the purchased goods.

Consumers not having access to electronic forms of payment, such as credit cards or traditional banking accounts may be provided an invoice, payment coupon, or some other payment document in a language and currency native to the consumer indicating a payment office where the consumer can make payment for their purchase. The payment office may be a bank or other institution capable of transacting business and interfacing with the system of the present invention. The receipt may additionally indicate to the consumer and payment office the some identifying number related to the purchase, such as a transaction number or account number, and that a payment related to the purchase of goods is required. The payment invoice may include a barcode and be a multi-part document.

Payment offices adapted for interacting with the system may accept payment based on information indicated on the invoice. The consumer may present the payment office with the invoice and payment, informing the office representative to make payment on behalf of the account indicated on the invoice, updating the record. The consumer may make a full or partial payment against one or more purchase accounts. The consumer may make a payment with cash or credit mechanisms in local currency that may or may not otherwise be recognized by vendors. The system may guarantee payment to the vendor. Upon entry of the payment information at the payment office, the consumer may receive a confirmation of payment, whether the original invoice is further documented or a new receipt is given.

By acceptance of payment from the consumer and update of the account record, the system at the bank will receive notification that the purchase can proceed. The system at the bank can be adapted to communicate payment with the bank, the remote facility, and central location by signaling that sufficient payment has been received. The central location may be the processing center of the Imalls Platform. Verification of the complete payment can release the purchase for processing and shipment to the consumer or his/her remote location of choice. Payments can be consolidated and the total amount deposited into an account for the system. Using Bank Direct the system can initiate domestic payments for the purchased goods.

In one embodiment, the system and methods comprise delivery logistics of goods to the customer's remote location, or an alternative location of his choice, where a universally recognizable deliverable mailing address is not available for the customer's home or business location and is not recognized as a deliverable address by the vendor. A consumer may purchase goods through the system and methods of the present invention through which the purchase is made with an address at a central location warehouse, such as in the United States. The consumer will appear to a U.S. vendor as a U.S. customer enabling the vendor's programs to accept the order and ship the goods to the central, consolidating location, ultimately arriving at the remote location.

In one embodiment, the system and methods comprise a stand-alone service to universally interface with commercially developed e-commerce systems using X12 and UN/EDIFACT Standards for business data exchange. The system and methods may also comprise an aggregate component service to universally interface with commercially developed e-commerce systems using X12 and UN/EDIFACT Standards for business data exchange. New standards may be created where interface standards do not yet currently exist. The system may also comprise a central web portal to consolidate and promote vendors and vendor's products.

Software modules may provide a web portal, known as an Imalls portal, to redirect customers to trusted vendor web store-fronts. A central store-front, such as an Imalls store-front, may also be provided for those vendors wishing to only participate in the system by providing product catalogs. The software modules interact with both the central store-front and the vendor store-fronts. The modules perform functions comprising: language translation, transparent pricing, currency exchange translation, addressing/shipping logistics, payment confirmation processing, and non-catalog request for quote. Configuration of the software, including the modules provides the functionality comprising: Telecenter Account Management, Customer Accounts Management, Vendor Accounts Management, Currency management, Store-Front Catalog Management, Order Entry, Fulfillment, Payment and Payment Confirmation, Shipping Logistics, Order Status Monitoring (including delivery and receipt confirmation), Returns and Reverse Logistics, Customer Service, and Merchandizing.

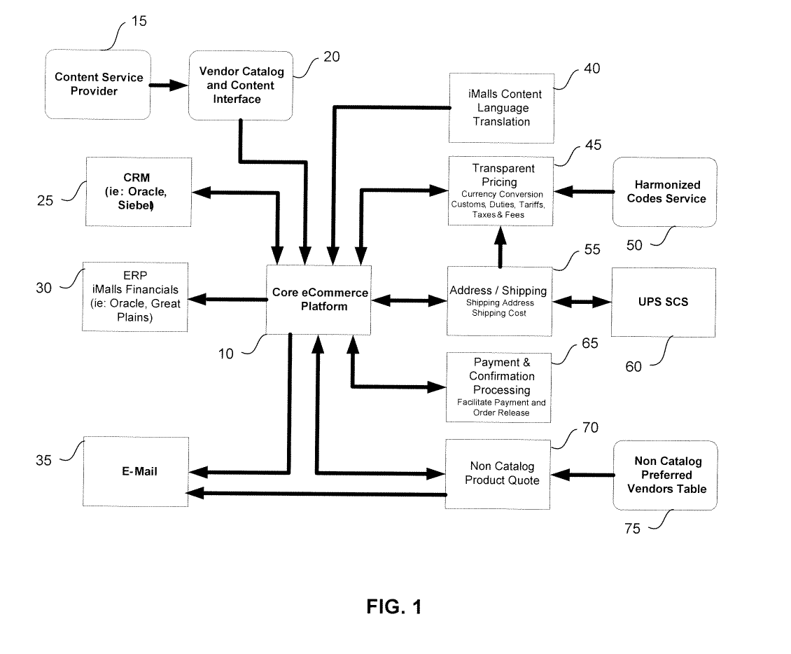

Embodiments of the software modules are described herein below and also detailed in FIG. 1 through FIG. 5.

Language Translation—a web page skin involves the provision of a fully translated HTML front-end for download and viewing by the consumer, including the menu items, tabs, buttons, side bars, etc. Skins are one of two elements of the e-commerce store-front requiring translation for a consumer. Skins further provide the dialog and control interface for backend system modules. In the present invention described herein, a default language of a skin may be that native to a region, and can be determined by a customer's IP address and customer profile settings. The language of the skin presented may depend on the location of the computer identified by IP address, may be overridden by the customer's account preferences, and may also be changed by the customer in real time by selecting the language from a drop down control. Selection of the language can be from a list of various predetermined languages. The skin of the central store-front and vendors web sites presented through the web portal are translated into the one of the predetermined languages by a software module adapted to produce translations of various predetermined languages.

Translation of the catalog, the second of two e-commerce storefront elements, can be implemented as a result of the selection made for the skin and reflect the same selection as the skin. In one embodiment, translation of the catalog can occur in real-time upon presentation of goods. The catalog database is typically stored in English although any language from a predetermined list can be used.

Transparent Pricing—The cost of the goods may be passed to the Transparent Pricing (TP) module for processing. As used herein the term “goods” includes, but is not limited to one or more goods, services, or items for purchase in normal channels of e-commerce. The cost of the goods may be stored by means of a database in a vendor catalog. The vendor catalog may reside in the central system, or in an affiliate vendor's system. Configurable business rules are used to build a specific algorithm applied to the cost of the goods, rates and other constants as they apply to the specific country and region of destination. The Transaction Pricing module can use information from the Addressing/Shipping Logistics (ASL) module, described herein below, as well as information related to the goods from the catalog, including size and weight to calculate the shipping and handling fees. Rates from the carrier can also be used to calculate shipping and handling fees. These fees may be combined by an algorithm producing a shipping fee and handling variable that when further combined, such as by multiplying, with a configurable constant may result in the specific handling fee. The Transaction Pricing module may also calculate value-added tax, customs fees and any other fees that are specific to shipping goods from origin to the destination as may be necessary. The module can also apply a transaction fee which is also generated by a configurable algorithm. The module has additional fee fields reserved for future use. These algorithms comprise the full landed costs.

When the customer opens a vendor's web site within the Web portal window, the vendor's system becomes “aware” the customer is connecting through the Web portal. The vendor's e-commerce system passes the cost of any goods presented to the customer to the Transparent Pricing module and suppresses its own shopping cart functionality. The fully landed cost of the goods are presented in a window within the Web portal and translated into local currency and presented as an integrated shopping cart. When the customer completes the this portion of the purchase, the transaction information is passed to the central system for processing. The order is then suspended in the Payment Confirmation Module, described herein below, until released for fulfillment. In one embodiment, the transaction may be passed to the Web portal for processing within its e-commerce engine. In an alternative embodiment the module may be interfaced with any other e-commerce engine for processes as the module is fully independent. Upon completion of the transaction, the currency exchange rate is saved with the transaction. In one embodiment, The Transaction Pricing module may provide an additional GUI interface to manually calculate landed cost on any cost that is entered along with other parameters normally captured from the transaction. This screen may be used by customer service personnel as a tool for providing support and completing requests for quotes, which may not otherwise be completed automatically.

Addressing/Shipping Logistics—The Addressing/Shipping Logistics module manages the origin, destination and intermediate consolidation points in the supply chain. The module generates information used by the Transparent Pricing module for shipping and handling fee calculations. The module interfaces with carrier supply chain services, such as UPS, and similar systems of other shipping carriers. The module accepts and uses rate information passed to it from the carriers' supply chain services to accurately generate shipping cost information based on the consolidation of goods, which reduce shipping costs and customs transaction fees. The module also processes and stores delivery and receipt confirmation when a remote location such as a Telecenter is used as the delivery address. The module may process order status when the item arrives at the remote location, such as by indicating the order was delivered. The module can record the name of the individual at the remote location receiving the goods. The goods can then be secured in a stock room or cabinet in anticipation of pickup by the consumer. The order status is changed from Delivered to Received when the customer completes the purchase by picking up the item.

Payment Confirmation Processing—The Payment Confirmation Processing module may be used to capture a purchase transaction and suspend it as a purchase requisition until payment has cleared. This module is employed when the customer pays for the item by means other than a recognized credit card (ie: Visa, Master Card, etc.). When the customer elects to pay by cash, check or other unrecognized debit/credit card, the payment may be made to a local bank. When the customer completes their purchase requisition, an order confirmation number and invoice is generated. The form can be printed with the information needed to make the payment at a bank and includes a bar code that can be scanned at the bank, which enhances the efficiency and security of the transaction. Electronic Bank to Bank notifications can be used to consolidate the payments into a single international bank account, ensuring payment integrity for e-commerce transactions in remote regions that are known for fraud. Payment status can be automatically queried several times per day. The central system electronically interfaces with the international bank several times per day. The requisition can be automatically released when the bank record indicating successful cleared payment is received by the central system. The order may then processed with the vendor for fulfillment, delivery and receipt verification.

Non-Catalog Request for Quote (NCRFQ)—The system provides for users in remote regions access to any product that is available for sale on the internet. If a customer has not successfully found goods on the system catalog or affiliate vendor catalog, the module provides access to any available web site so as a consumer may continue searching for the desired goods. Upon finding the goods at an alternative web site, consumers are instructed to ‘click’ a Request for Quote Button. As a result the content of the vendor's web screen is captured as an image along with the URL of the product page from the vendor's web site. The module attempts to acquire information from the page such as product image, description and cost. The NCRFQ record is saved with any incomplete fields of the NCRFQ flagged. A customer service representative of the system is immediately notified of the pending NCRFQ. A customer service representative opening the record is presented with the purchase information and are prompted to complete missing or potentially incorrect information. Validation of the web site may be required if the vendor web site is not recognized by the system. The customer service representative may be prompted to validate the web site by the system. When all of the fields are complete, the NCRFQ module interfaces with the Transparent Pricing module to generate the fully landed cost. A quote is then created and sent to the customer by email or other methods of communication previously described herein. When the customer receives the communication, they will have the option to accept or reject the quote. If the quote is accepted, the transaction is placed as a suspended requisition, as described previously herein, until payment is made. Once payment has been verified, the order is processed for fulfillment, shipping and delivery. If the quote is rejected, a customer service representative is prompted to contact the customer to assist. In a further embodiment, there is provided a text box wherein the customer may describe the goods sought. Additional fields, such as cost or category of goods, may be required to further characterize the product. A customer service representative might search for the goods to further complete a NCRFQ. Customer service might locate the product on the web or through other sources, creating the quote with a set of automation tools designed to expedite the process. Once the quote is delivered to the customer, the NCRFQ is processed as described herein above.

FIG. 1 illustrates one embodiment of the software platform. The Core e-Commerce Platform 10 receives input from Content Service Provider 15 via a Vendor Catalog and Content Interface 20, supplying catalog data related to goods. Customer Relations Management software 25, such as Oracle, may be implemented to manage customers and vendors communications and transactions. Additional over the counter products, such as Oracle or Great Plains Enterprise Resource Management tools 30 can be implemented to facilitate the systems financial records. The system may use email 35 to communicate between the Platform 10 and customers or be used for sending a Non-Catalog Product Quote 70 to the customer for approval. A Non-Catalog Preferred Vendors Table 75 provides data to the Non-Catalog Product Quote module 70 regarding vendors that have not provided catalogs but are known and accepted. Alternatively, a web search (not shown) may be performed with information communicated back to the Non-Catalog Product Quote module 70 to assist customers with finding additional products on the web. Additional resources used by the Platform 10 may include a Language Translation Module 40, and Transparent Pricing module 45, converting data received from Harmonized Code Services 50 into currency conversion data for the customer in addition to data from the Address/Shipping module 55. Transparent pricing module may provide customs duties, tariffs, taxes and fees to platform 10 along with other relevant transaction data. Transparent Pricing Module may receive support data from Platform 10, facilitating generation of the currency conversion, custom duties, tariffs, taxes and fees. Additionally the Transparent Pricing Module might relieve supporting data from Address/Shipping Module 55 to aide in the generation of relevant currency and customs duties, tariffs, taxes and fees. The address shipping module communicates with the Platform 10 and logistics service provider sources such as the UPS Supply Chain Services 60 to extract shipping cost data used by the platform and other modules to provide full landed costs to the consumer. Information may be transmitted to and from the Platform 10 or the Supply Chain Service 60 to acquire data sufficient to provide the customer the full landed cost of a purchase. Platform 10 additionally communicates with a Payment & Confirmation Processing module 65, to facilitate payment and order release so the customer may receive their purchased goods. A web service interface (not shown) can also communicate with the Payment & Confirmation Processing module 65, acting as a vendor order pipeline.

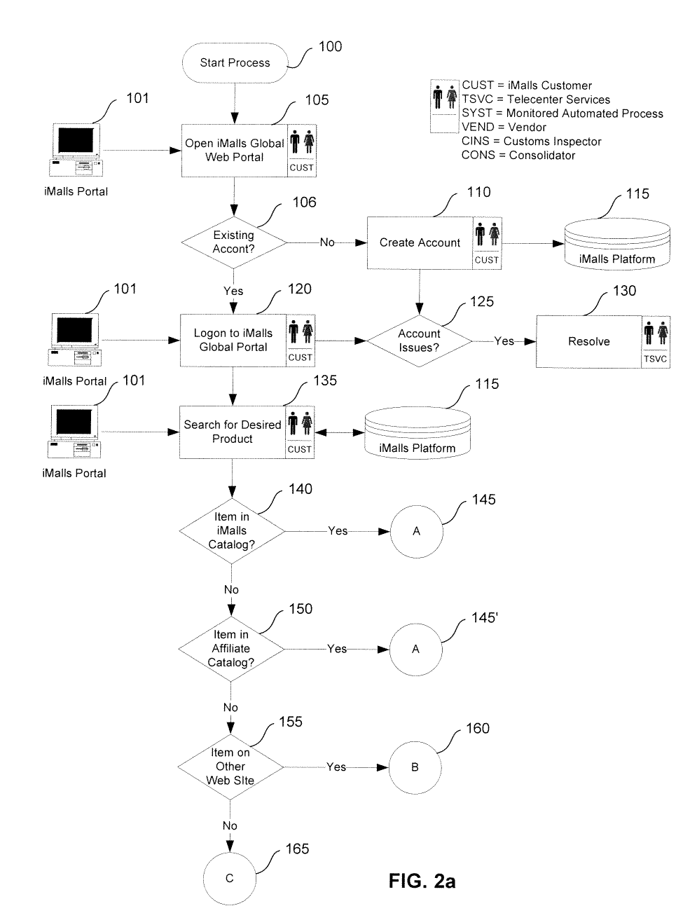

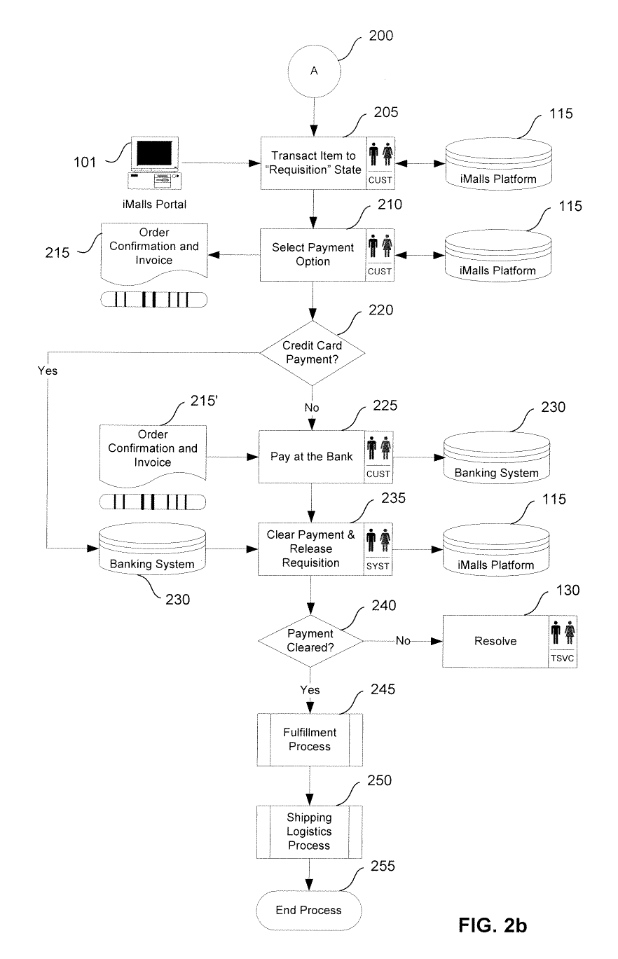

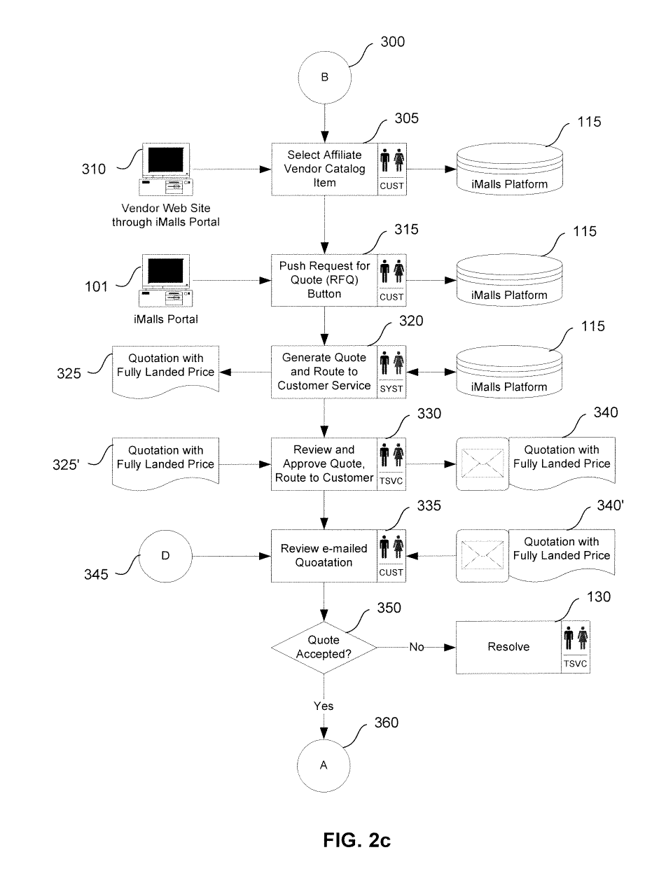

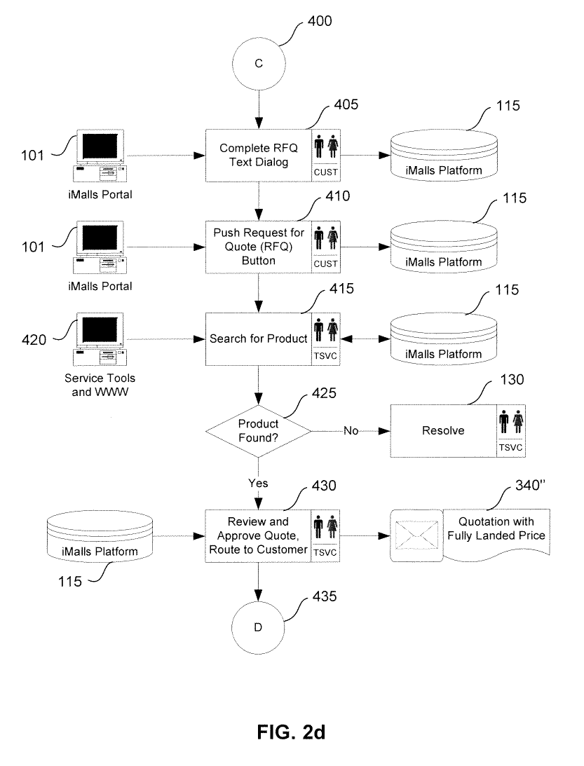

FIG. 2a-2d is an embodiment of one transaction process possible with the system of the present invention. The process Starts 100 when a customer opens 105 a web portal 101 to begin a purchase. An account is querried for existence 106 and if not an account can be created 110 for the customer and indicated in the Platform 115. If there are issues with the account 125 the matter may go to resolution 130 for addition assistance from a service center such as a Telecenter. If the system query 106 determines an account does exist the customer is allowed to logon 120 to the portal 101. Again if there are issues 125 with the logon process the matter may go to resolution 130 for additional assistance from the service center. Once the customer has gain access to the system the Platform 115 and the Portal 101 will provide the customer with the ability to search 135 for desired products. If the system determines 140 an item sought by the customer is in the system catalog 140 the process proceeds via step A 145, 200 to transact the item to “Requisition” state 205, as described in embodiment shown in FIG. 2b. If the system determines 140 the item is not available in the Imall catalog, the system may determine 150 if the item is available in an affiliate catalog 150 the process proceeds via step A 145, 200 to transact the item to “Requisition” state 205, FIG. 2b. If the product is not found on either the two previous catalogs but is found on another web site 155 the process proceeds via step B 160, 300 to allow the customer to select the affiliate catalog item 305, FIG. 2c. If the product is not found by the previous methods, the process proceeds to step C 165,400 to provide the customer the opportunity to purchase the product in an alternative manner by completing a Request For Quote (RFQ) 405, FIG. 2d.

Successful acquisition of the sought item(s) from the two catalogs described herein above places the item(s) in a requisition state, receiving input from the portal 101 and communicating between the Platform 115. The customer can then select a payment option 210, transmitting and receiving identifying information from the Platform 115, producing an order confirmation 215, which the customer can use as a record of his purchase. If the customer has the capacity to complete the financial potion of the purchase via credit card payment 220 the Banking System 230 will automatically inform the Clear Payment & Release Requisition module 235 that payment has been made. If the customer elects to pay by other than credit card, the Order Confirmation and Invoice 215′, received previously is submitted with payment by the customer to the bank 225, a record of which is made at the Banking System 230. As characterized herein above, the payment is entered for requisition release and communicated to the Platform 115. If the payment has cleared 240, by either credit card or other means, the order is fulfilled 245 and shipping logistics are initiated 250, where after the product would be received by the customer in the remote location of his choice and the process ends 255. If the payment did not clear 240, the matter may go to resolution 130 for additional assistance from the service center.

As described herein above, if the customer selects affiliate vendor catalog item(s) 305, FIG. 2c, of which data from the vendor's website associated portal 310 is provided, the Platform 115, accepts data associated to the selection. When the customer has completed his selection he may elect to request a quote by pushing the RFQ button 315, provided by the Portal 101. Again, data associated with the selection, including the RFQ is recorded at the Platform 115, and used to Generate 320 a Quotation 325 with full landed price and route the quote to Customer Service. The Quotation 325′ is Reviewed 330 by customer service for Approval, and Routing to the customer. The customer receives an email communication 340 indicating the quotation with the fully landed price. The customer has the opportunity to Review 335 the quotation 340′ and accept 350 or decline the offer. If the customer declines the matter may go to resolution 130 for additional assistance from the service center. If the customer accepts the quotation the process proceeds at step A 360 as previously described herein.

As previously described herein above, selection of item(s) not associated with either catalog may result in the customer completing a Request for Quote Text Dialog 405, via the Portal 101, where data is captured by the Platform 115. The customer is provided the means, via the Portal 101 to push a button 410 to request the quotation. The selection is recorded on the Platform 115 and used by the system and service personnel to search 415 for the product using Service Tools 420 and the World Wide Web. If the product is not found 425 the matter may go to resolution 130 for additional assistance from the service center. If the product is found 425 the system and service will provide review approval and routing 430 means, including data provided by the Platform 115 to send the quote to the customer. The customer receives an email communication 340″ indicating the quotation with the fully landed price. The process then proceeds via step 435,345 to allow the customer to review the quotation 335, as previously described herein.

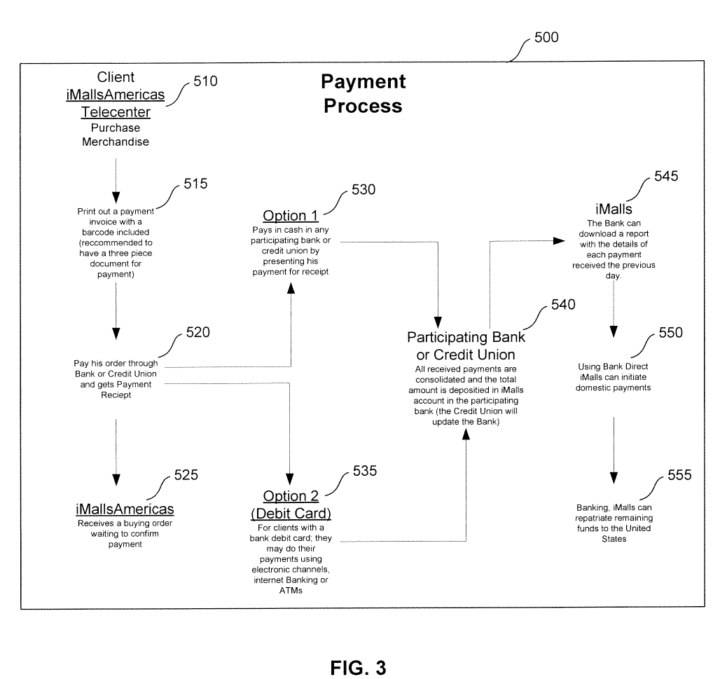

One embodiment of the payment process is depicted in FIG. 3. The customer (client) 510, purchases good(s) (merchandise), printing out a payment invoice 515. The payment invoice may be a multi-copy invoice and may include barcoding. The customer has the option when paying at the Bank or Credit Union 520, where he would obtain a receipt, to either pay in cash 530, presenting his payment for receipt, or using an electronic form such as a debit card 535. In the meantime the system (iMallsAmerica) is awaiting confirmation of payment while having received and holding a buying order 525. Payments are consolidated at a participating bank 540 and deposited. The system (iMalls) can receive a downloaded report from the bank 545 and initiate domestic payments 550 where the system (iMalls), can repatriate remaining funds 555 to the United States.

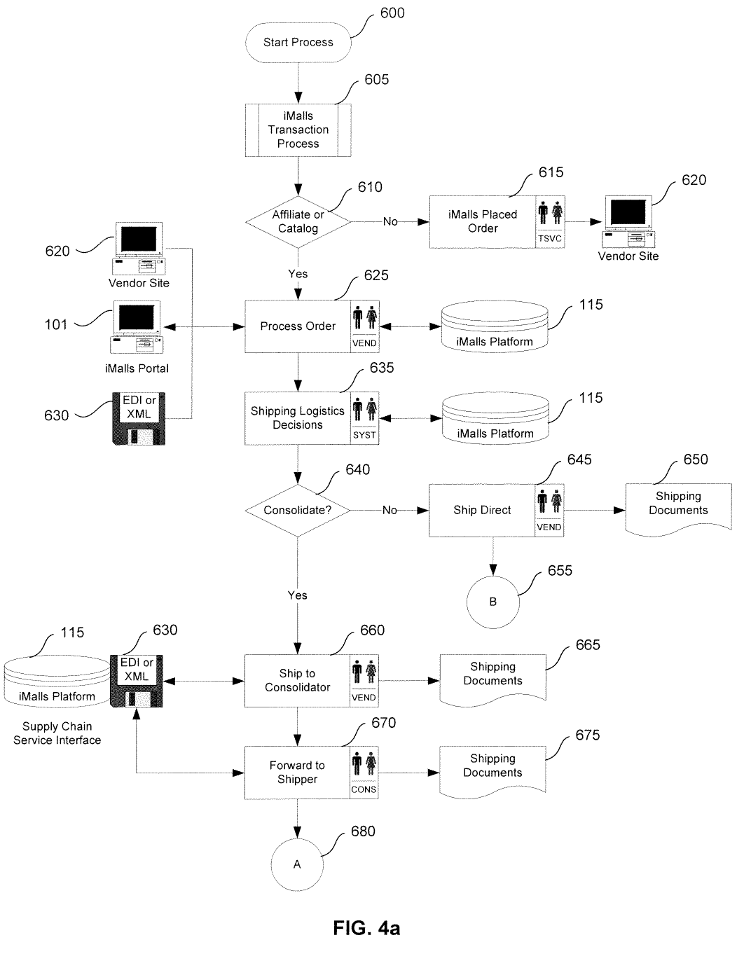

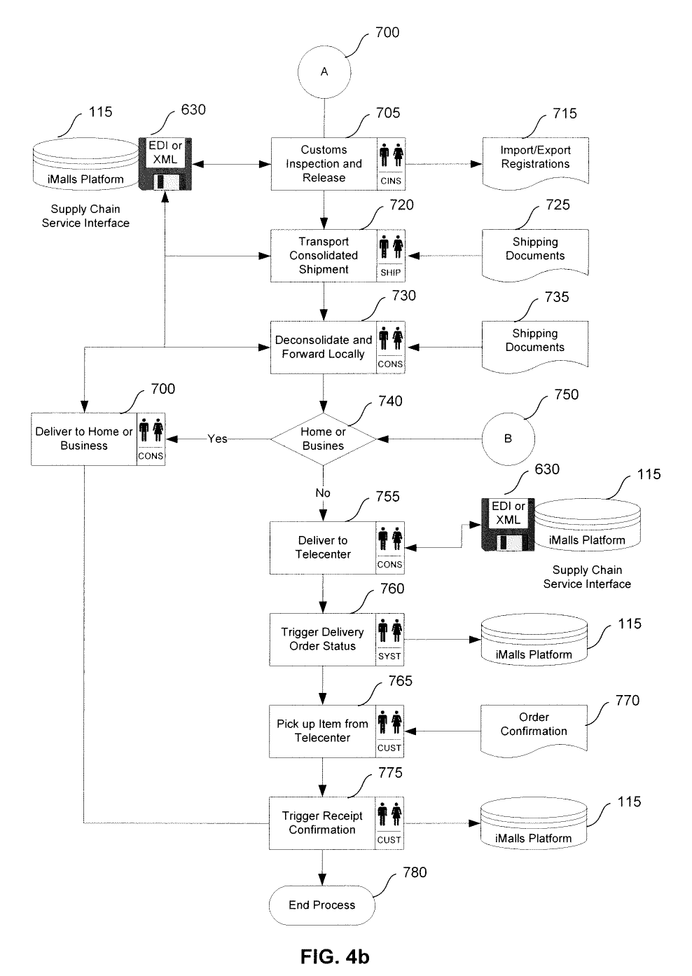

A shipping logistics process is illustrated by the embodiment of FIG. 4a-b. The process Starts 600 wherein the Transaction Process 605 is provided with the relevant details such as order confirmation, shipping weight, carrier, method of shipment, shipping location and addressee. A determination 610 is made whether the transaction was through an Affiliate vendor or the catalog (tier 1 or 2). If the purchase was by neither, the Order is placed 615 by the service personnel via a Vendor Site 620. Alternatively, if the determination 610 is made that the goods transacted through the Affiliate or catalog the order is processed 625 by the vendor with detail information provided to and from the Platform 115, and to and from each the Vendor Site 620, the portal 101, such as the iMall portal, and the EDI/XML storage. Information details provided from the Platform 115, can include some or all of the information, heretofore provided by previous processes. Data might include completion of the RFQ Text Dialog 405; the push for RFQ 410; the search criteria and/or search results for products conducted by services personnel 415; information from the affiliate vendor catalog 305; push for RFQ 315; the results from the generation of a quote 320; the payment option selected by the customer 210; the clearance of the payment and release of the requisition by the system 235; the account details 110 of the customer, including name, address, bank to facilitate the transaction and tracking numbers and the description of the product 135 the customer desires to mention just a few. Information provided to the Platform 115 by the system and or vendor during or upon completion of order processing might include production descriptions, product numbers, warehousing information and logistics of obtaining the products from the stored locations or places of manufacturing. Shipping Logistics decisions 635 are made in response to the information gained from the process so far and is shared with the Platform 115. Determination 640 whether to consolidate or not is made. Consolidation can be for one or more products destine to one or more customers from one or more vendors, or any combination thereof. If consolidation is not to occur the vendor is notified to ship direct 645 and the shipping documents 650 are produced along with determination of whether the shipping address is a home or business 740 via process step B 655, 750 in FIG. 4b. If consolidation is to occur, the vendor is notified and the vendor will ship the products to the consolidation site 660, known as the Consolidator, and produce the required shipping documents 665. The vendor will provide information of such shipment to the Platform 115 and EDI/XML location 630 where the products can be tracked by the system. A supply chain service interface may be provided and used for the communication of information to and from the consolidator or any concern requiring such communication pathway to enable the receipt of the goods by the customer. This information along with the products may be forwarded 670 to the shipper. The forwarding process to the shipper might include additional production of shipping documents 675 to facilitate record keeping and tracking of the products through the system. Via step A 680, 700 of FIG. 4b, Customs may perform an inspection 705 of the products prior to release, again acquiring and providing information to and from aforementioned Platform 115 and EDI/XML 630 location. In addition, the inspection and release of the products may provide additional documentation such as Import/Export registrations 715 for proof of valid exit and entry from the originating location and the final destination. Registrations may also be provided for transient locations necessary for the delivery of the goods. The consolidated goods are shipped 720, receiving and providing additional information to the Platform 115 and EDI/XML 630. Information relevant to the shipment may flow between the Platform, the Customs Service for Customs Inspection 705, the shipper for Transportation of Consolidated Shipments 720, the Vendor for consolidation 660, the Consolidator for Forwarding to the Shipper 670, Deconsolidation and Local Forwarding 730, and Delivery to the home or business 700 as requested by the consumer. Upon arrival at a predetermined intermediate location, the consolidator will deconsolidate 730 the shipment and forward it locally. If the customer has previously indicated the shipment is destined for home or business deliver, the system or a system operator will review the available records from all sources, such as the Platform 115 in determining 740 how or where to direct the shipment. Home or business deliver may be performed 700 by the consolidator, with a receipt confirmation process 775 and update of the Platform 115 completing the transaction 780. Alternatively, a determination 740 can be made, whereupon the customer has indicated they will pick up the goods from a local or remote Telecenter. If the customer has no address, home or business, he/she could have indicated during the ordering process to have the goods delivered to a local Telecenter 755 and held for pick up. Data stored at the EDI/XML location 630 and on the Platform 115 might be provided to direct the shipment to the Telecenter. Arrival of the goods at the Telecenter might trigger a system update of the delivery status 760, sending data to the Platform 115, to show the goods have arrived. The customer may be informed by one of several means, including but not limited to email, regular mail or online message at the Telecenter which the customer may check periodically for arrival of the goods. Providing a copy of the order confirmation, the user can retrieve the goods ordered once they arrive. A triggering of a receipt confirmation 775 for the customer is performed as well as information that the transaction has been completed is made available to the Platform 115, after which the transaction is complete 780.

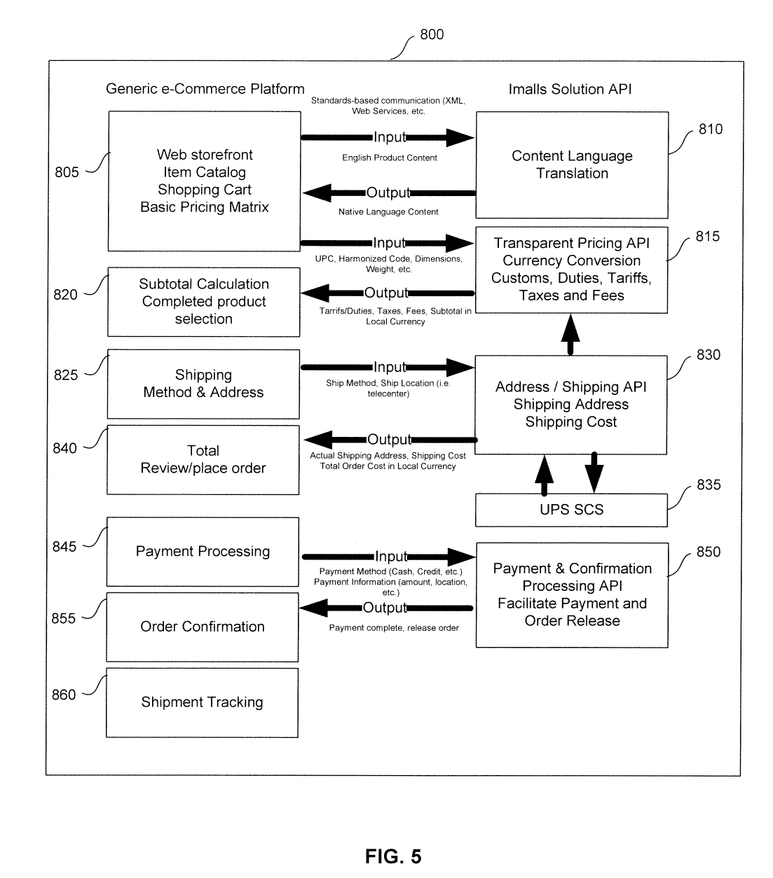

One embodiment of the International Internet shopping process 800 is illustrated in FIG. 5 Web storefront, item catalog, shopping cart, and basic pricing matrix 805 are passed as input to a content language translation module 810, possibly as English and returned as output in a native language to the customer. Results of the customers selections within the Web Storefront 805, including UPC, Harmonized codes, Dimensional data and Weight, etc. are passed to a Transparent pricing API 815 where currency conversion may be performed and customs, duties, tariffs, taxes and fees can determined. Output from the Transparent Pricing API 815 is passed in local currency to the customer to show Subtotal Calculation and Completed product selection 820 results. The customer would be allowed to provide the shipping method and address 825 to the Shipping API 830, where shipping costs can be determined from the interface with a system such as a UPS SCS 835. Verification of the shipping information including the shipping costs and total cost in local currency is provided back to the customer as output to a Total Review/Place Order 840 form where the customer may indicate their desire to have the order fulfilled. Payment processing information 845 from the user is input to a payment and confirmation processing API 850 where the customers payment information is processed and the order released should the payment be successful. Results of the payment and order release are output to the Order Confirmation form 855 and information related to the shipment tracking 860 is provided.

Some or all of the modules described herein may be contained within a centralized location such as a single server, or be distributed across multiple servers in multiple locations, and may be physically remote from one another. The system and methods may be implemented in digital electronic circuitry, or in computer hardware, firmware, software, or in combinations of them. Systems may be implemented in a computer program product tangibly embodied in a machine-readable storage device for execution by a programmable processor; and method steps of the invention may be performed by a programmable processor executing a program of instructions to perform functions of the invention by operating on input data and generating output. Input and output data may be received and transmitted in the singular or plural. Implementation may be in one or more computer programs that are executable on a programmable system including at least one programmable processor coupled to receive data and instructions from, and to transmit data and instructions to, a data storage system, at least one input device, and at least one output device, wherein the input and output devices may be interfaced with one or more other system devices. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Instructions, however, may come directly from an input or output device and may or may not use a storage device before, during or after processing. Data operated on by a processor may be processed by a processor and returned to the same or alternative location from where it came without storing the input data or output data. Instructions for controlling a processor may come from outside the system by way of user input via a single command or a multitude of commands or may originate within the system itself in the form of one or more parameters. Storage devices suitable for embodying computer program instructions and data include all forms of memory (volatile and non-volatile), including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

### STATEMENT REGARDING PREFERRED EMBODIMENTS

While the invention has been described with respect to the foregoing, those skilled in the art will readily appreciate that various changes and/or modifications can be made to the invention without departing from the spirit or scope of the invention as defined by the appended claims.

1. A computer implemented transaction method for allowing a user at a remote location without an acceptable distributed network address or a valid bank account to purchase products over a distributed network, said method comprising the steps of:
associating with said remote location an acceptable distributed network address;
obtaining from said remote location a selection of products to purchase;
determining the full landed costs to deliver said selected products to said remote location taking into account the location of the remote location, as well as the weight and the dimensions of the selected products;
transmitting the full landed costs to the remote location;
accepting from the remote location after transmission of said full landed cost an indication to complete the purchase of one or more selected products;
providing an invoice to the remote location for presentation to a remote bank maintaining a bank account operatively configured to communicate with said distributed network;
accepting from said remote bank an indication payment related to the invoice has been made;
authorizing shipment of said one or more selected products to and acceptable distribution shipment address; and
causing shipment of said one or more selected products from said acceptable distribution shipping address to said remote location.

2. The method of claim 1, further comprising the step of obtaining from the remote location a request for quote on said selection of products offered from a nonaffiliated vendor.

3. The method of claim 1, further comprising the steps of:
accepting product data content in a foreign language;
translating said product data content to an alternate language; and
transmitting said translated content data to the remote location.

4. The method of claim 1, wherein the full landed cost is in a user selected currency.

5. The method of claim 3, wherein the alternate language is selected by the user.

6. The method of claim 1, further comprising the step of transmitting to the user an indication the shipment of one or more selected products has arrived.

7. The method of claim 1, further comprising the step of receiving from the remote location indication of payment into a debit account prior to selection of one or more products for purchase and from which monies can be drawn to complete the transaction.

8. The method of claim 2, wherein payment to the non-affiliated vendor is made on behalf of the remote location using payment methods comprising: credit card, wire transfer, and invoicing.

9. The method of claim 3, wherein the product data content is targeted advertising.

10. A computer implemented system for providing translated content data and full landed costs to e-commerce participants without bank accounts or recognizable addresses, said system comprising:
a remote application program interface operatively connected to an e-commerce platform;
a vendor catalog and content interface operatively connected to the e-commerce platform;
a content language translator operatively configured to receive the vendor catalog and content and return the vendor catalog and content in a language selected by a user;
a pricing module operatively configured to receive product harmonized codes and addressing data from multiple sources, wherein said pricing module is configured to determine the full landed cost of a product to the user;
a payment and confirmation processing module operatively interfaced to facilitate payment and order release for the product to the user; and
a non-catalog product quote module operatively interfaced to the e-commerce platform and associated with a table of non-catalog preferred vendors.
